(19) United States
(12) Patent Application Publication
(10) Pub. No.: US 2026/0285362 A1
(43) Pub. Date: Sep. 24, 2026

(54) SYSTEM FOR RECOGNIZING AND TRACKING OBJECT BASED ON AUTONOMOUS DRIVING SENSOR AND ARTIFICIAL INTELLIGENCE AND METHOD IMPLEMENTING THE SAME

(71) Applicants: Hyundai Motor Company, Seoul (KR); Kia Corporation, Seoul (KR)

(72) Inventor: Hyun Ju KIM, Hwaseong-Si (KR)

(21) Appl. No.: 19/354,374

(22) Filed: Oct. 9, 2025

(30) Foreign Application Priority Data
Mar. 18, 2025 (KR) 10-2025-0034565

(51) Int. Cl. B60W 60/00; B60W 50/00; G06T 7/246; G06V 10/25; G06V 10/762; G06V 10/764; G06V 20/58

(52) U.S. Cl. CPC B60W 60/001; B60W 50/00; G06T 7/246; G06V 10/25; G06V 10/762; G06V 10/764; G06V 20/58; B60W 2050/0052; B60W 2520/06; B60W 2520/10; B60W 2520/12; B60W 2554/4042; B60W 2554/4044; B60W 2556/05; B60W 2556/40; G06T 2207/30252

(57) ABSTRACT

An apparatus of a vehicle may comprise a sensor configured to obtain pieces of point data associated with an object in a surrounding environment of the vehicle, a memory configured to store the pieces of point data, and a processor circuit. The processor circuit may recognize, based on the pieces of point data, the object, wherein the pieces of point data are processed based on an artificial intelligence (AI) model associated with autonomous driving of the vehicle. The processor circuit may obtain class information and predicted bounding box (P-Box) information through segmentation and clustering, generate a driving environment map, output tracking information adjusted for time delay, and control autonomous driving of the vehicle.

### CROSS-REFERENCE TO RELATED APPLICATION

This application claims the benefit of priority to Korean Patent Application No. 10-2025-0034565, filed in the Korean Intellectual Property Office on Mar. 18, 2025, the entire contents of which are incorporated herein by reference.

### TECHNICAL FIELD

The present disclosure relates to a system and a method for detecting and tracking an object by using Artificial Intelligence (AI) and an autonomous driving sensor, and more particularly, relates to a system for recognizing and tracking an object by using AI and an autonomous driving sensor that is capable of accurately recognizing and tracking an object while being robust to various types of noise on a road that interfere with object recognition, and a method thereof.

### BACKGROUND

The matters described in this Background section are only for enhancement of understanding of the background of the disclosure, and should not be taken as acknowledgment that they correspond to prior art already known to those skilled in the art.

A variety of sensors and AI technologies are increasingly being used to support an autonomous driving function of a vehicle. For example, research on an object in front of a moving vehicle, a distance between the object and the vehicle, and an algorithm in which the vehicle responds to specific situations to ensure safety is ongoing.

Accordingly, a vehicle sensor technology is becoming advanced, and high-performance sensors such as Light Detection and Ranging (LiDAR) that recognizes surrounding environments by using laser beams, Radio Detection and Ranging (RADAR) that uses radio waves, an ultrasonic sensor, a fisheye camera capable of capturing 360-degree images, a multifocal lens, and a global positioning system (GPS) are being installed in vehicles.

As such, a super sensor vehicle may be implemented by aggregating measurement results obtained from a plurality of sensors. In self-driving (autonomous driving), the concept of a super sensor refers to a technology that accurately recognizes surrounding environments for comfort or safety by combining measured values from a variety of sensors rather than relying on individual sensors. Here, with the addition of information and communications technology (ICT) and cloud technology, sensors required for autonomous driving, and AI algorithms related thereto are becoming more sophisticated than ever, to increase the reliability of the determination of vehicle sensors by remotely accumulating data from numerous fleets of vehicles without targeting only a single vehicle and training an AI server and a database.

Among the sensors, the LiDAR sensor for recognizing external environments recognizes various objects on a road during autonomous driving by emitting a laser beam, and measuring the intensity of the laser and the time required for the laser beam to be reflected from surrounding objects.

Object recognition using the LiDAR and the AI algorithm may not be perfect. Despite the advancement of LiDAR sensing performance and advancement of AI technology, there is still a technical need for accurate object recognition.

### SUMMARY

The present disclosure was made to solve the above-mentioned problems.

An example of the present disclosure provides a system and a method for detecting and tracking an object by using an AI and an autonomous driving sensor, and more particularly, provides a system for recognizing and tracking an object by using AI and an autonomous driving sensor that is capable of accurately recognizing and tracking an object while being robust to various types of noise on a road that interfere with object recognition, and a method thereof.

Moreover, the technical challenges of the present disclosure are not limited to the technical challenges mentioned above, and other technical challenges not expressly mentioned will be apparent to those skilled in the art from the detailed description of the present disclosure and the accompanying drawings.

The technical problems to be solved by the present disclosure are not limited to the aforementioned problems, and any other technical problems not mentioned herein will be clearly understood from the following description by those skilled in the art to which the present disclosure pertains.

To solve all or at least part of the above-described technical problems, the present disclosure may be implemented in various examples as follows.

According to the present disclosure, an apparatus of a vehicle may comprise a sensor configured to obtain pieces of point data associated with an object in a surrounding environment of the vehicle, a memory configured to store the pieces of point data, and a processor circuit. The processor circuit may be configured to recognize, based on the pieces of point data, the object, wherein the pieces of point data are processed based on an artificial intelligence (AI) model associated with autonomous driving of the vehicle. The processor circuit may be further configured to obtain class information of the object and predicted bounding box (P-Box) information, wherein the P-Box information is obtained through segmentation and clustering of the pieces of point data, and wherein the object is tracked based on the P-Box information. Based on the P-Box information, the class information, and the pieces of point data, the processor circuit may generate a driving environment map associated with autonomous driving of the vehicle. The processor circuit may output, based on the class information and the driving environment map, a signal indicating tracking information about the object, wherein the tracking information is adjusted to compensate for a time delay between the obtaining of the pieces of point data and the output of the signal, and may control, based on the signal, autonomous driving of the vehicle.

The processor circuit may be configured to update information about the vehicle based on information about at least one of a transverse speed of the vehicle, a longitudinal speed of the vehicle, or an angle of the vehicle, and may generate tracking information based on at least one of updating tracking channels associated with the segmentation and the clustering of the pieces of point data, verifying the tracking channels to remove false tracks caused by noise, generating a new tracking channel for a cluster of point data not associated with an existing tracking channel, or retaining a tracking channel for a second cluster of point data when the second cluster is not associated with point data in a current frame obtained by the sensor.

The processor circuit may be configured to, based on the P-Box information and the class information, select at least one meta object among a plurality of meta objects in the surrounding environment of the vehicle.

The at least one meta object may comprise bushes in the surrounding environment of the vehicle.

The processor circuit may be configured to, based on a number of the plurality of meta objects exceeding a number of output tracking channels associated with the sensor, determine priorities of the plurality of meta objects, and exclude, based on the priorities, the at least one meta object from the generation of the driving environment map and the output of the signal.

The at least one meta object may comprise at least one of a meta object resulting from under-segmentation in which multiple objects are grouped as one, a meta object resulting from over-segmentation in which a single object is divided into multiple objects, a curb noise object, an object comprising crosstalk noise, or an object with occlusion.

The processor circuit may be configured to, based on the at least one meta object not being associated with an existing tracking channel, generate a new tracking channel for the at least one meta object, and set the at least one meta object as a memory tracking target.

The processor circuit may be configured to update tracking channel information associated with the at least one meta object, and, based on whether a speed of the at least one meta object satisfies a threshold value, update tracking heading information associated with the at least one meta object.

The processor circuit may be configured to, based on clustered point information associated with the at least one meta object, determine whether a track of the at least one meta object is a false track.

The processor circuit may be configured to determine a channel reliability level for a tracking channel associated with the at least one meta object, wherein the channel reliability level is determined based on a sum of reliability levels associated with updating the tracking channel and an object reliability level obtained for the at least one meta object.

According to the present disclosure, a method performed by an apparatus of a vehicle may comprise obtaining, from a sensor of the vehicle, pieces of point data associated with an object in a surrounding environment of the vehicle, wherein the pieces of point data are processed based on an artificial intelligence (AI) model associated with autonomous driving of the vehicle. The method may further comprise obtaining class information of the object and predicted bounding box (P-Box) information, wherein the P-Box information is obtained through segmentation and clustering of the pieces of point data, and wherein the object is tracked based on the P-Box information. Based on the P-Box information, the class information, and the pieces of point data, the method may comprise generating a driving environment map associated with autonomous driving of the vehicle. The method may also comprise outputting, based on the class information and the driving environment map, a signal indicating tracking information about the object, wherein the tracking information is adjusted to compensate for a time delay between the obtaining of the pieces of point data and the outputting of the signal, and controlling, based on the signal, autonomous driving of the vehicle.

According to the present disclosure, a vehicle may comprise a sensor configured to obtain point data representing an external environment of the vehicle, a driving control circuit configured to control autonomous driving of the vehicle, and a processor circuit. The processor circuit may be configured to cause the vehicle to segment the point data into segmented point data, and cluster the segmented point data into clusters. The processor circuit may be further configured to obtain, based on the clusters, class information of an object represented by the clusters, generate a driving environment map based on the class information, the clusters, and the point data, and track, based on the driving environment map, the object across time to generate tracking information of the object. The tracking information may be generated based on at least one of updating tracking channels associated with the clusters, verifying the tracking channels to remove false tracks caused by noise, generating a new tracking channel for a cluster of point data not associated with an existing tracking channel, or retaining a tracking channel for a second cluster of point data when the second cluster is not associated with point data in a current frame obtained by the sensor. The processor circuit may further be configured to output a signal indicating the tracking information of the object, and control, via the driving control circuit and based on the signal, autonomous driving of the vehicle.

The processor circuit may be configured to cause the vehicle to update the driving environment map with road boundary information and a closest in-path vehicle.

The processor circuit may be configured to cause the vehicle to remove false tracks corresponding to at least one of exhaust fumes, road signs, or crosstalk noise.

The processor circuit may be configured to cause the vehicle to generate a virtual track based on previously detected point data of the object, and retain, based on the virtual track, a tracking channel for an occluded object.

### BRIEF DESCRIPTION OF THE DRAWINGS

The above and other objects, features and advantages of the present disclosure will be more apparent from the following detailed description taken in conjunction with the accompanying drawings:

FIG. 1 shows an example of an overall system for automatically recognizing an object and controlling a vehicle for the purpose of autonomous driving;

FIG. 2 shows an example of an operation process of an autonomous driving LiDAR perception software architecture-related system;

FIG. 3 shows an example of an algorithm for tracking an object based on an autonomous driving sensor and an AI;

FIG. 4 shows an example of an algorithm for tracking an object based on an autonomous driving sensor and an AI together with sub-processes thereof;

FIG. 5 shows an example of a functional module corresponding to each sub-process of an algorithm for tracking an object based on an autonomous driving sensor and an AI from a multi-object tracking viewpoint; and

FIG. 6 shows an example of a computing system for autonomous vehicle control and object recognition operations.

### DETAILED DESCRIPTION

Hereinafter, some examples of the present disclosure will be described in detail with reference to the accompanying drawings. In adding reference numerals to components of each drawing, it should be noted that the same components include the same reference numerals, although they are indicated on another drawing. Furthermore, in describing the examples of the present disclosure, detailed descriptions associated with well-known functions or configurations will be omitted when they may make subject matters of the present disclosure unnecessarily obscure.

In describing elements of an example of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms used herein, including technical or scientific terms, include the same meaning as commonly understood by one of ordinary skill in the technical field to which the present disclosure belongs. It will be understood that terms used herein should be interpreted as including a meaning that is consistent with their meaning in the context of the present disclosure and the relevant art and will not be interpreted in an idealized or overly formal sense unless expressly so defined herein. For example, in the present disclosure, term “object” includes substantially the same meaning as “gaegche (in Korean)”, and expressions “object” and “gaegche” are used interchangeably in the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of robust multi-object tracking with noise handling) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of robust multi-object tracking with noise handling) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of robust multi-object tracking with noise handling) described herein.

Minimum risk maneuver (MRM) operation(s) may also be controlled, for example, based on one or more features (e.g., feature of robust multi-object tracking with noise handling) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of robust multi-object tracking with noise handling) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of robust multi-object tracking with noise handling) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

An autonomous driving activation/deactivation operation may be controlled based on one or more features (e.g., feature of robust multi-object tracking with noise handling) described herein. In particular, a diagnostic control apparatus may determine a tracking status for objects around the vehicle from sensor data (e.g., LiDAR point clouds, radar returns, or camera detections) and gate autonomous driving accordingly. When the tracking status is normal (e.g., all detected objects are stably tracked within confidence thresholds despite environmental noise), autonomous driving may be enabled. When the tracking status is cautionary (e.g., one or more objects are intermittently lost, duplicated, or merged due to noise such as exhaust plumes, reflective road signs, or occlusion, etc.), autonomous driving may be restricted (e.g., speed/acceleration limits, route constraints, or reduced feature set), and a driver takeover request may be prepared. When the tracking status is critical (e.g., an object track is lost, falsely maintained, or corrupted by severe noise or occlusion), autonomous driving may be deactivated and a minimal risk maneuver initiated (e.g., controlled deceleration, lane-keeping to shoulder, or safe stop), while issuing a warning that includes tracking channel and object identification information.

According to the present disclosure, an apparatus and method are provided for improving object recognition and tracking in autonomous driving by combining data from vehicle-mounted sensors with artificial intelligence (AI). Approaches relying on LiDAR or other sensors alone may be hindered by noise such as exhaust fumes, bushes encroaching on the road, reflections, or occlusion where one object blocks another. To address these limitations, the present disclosure describes processing steps that include pre-processing sensor data to remove ground points and noise, segmenting and clustering the remaining data into probability boxes (P-Boxes), classifying objects into appropriate categories, and tracking the objects across time while compensating for delays and correcting errors such as false or overlapping tracks. By fusing AI-based deep learning techniques with signal processing logic, the apparatus may generate a reliable driving environment map and reliably recognize and track objects at near and long ranges. This approach enhances the ability of an autonomous vehicle to detect and respond to surrounding objects under diverse and challenging conditions, thereby improving driving safety and stability.

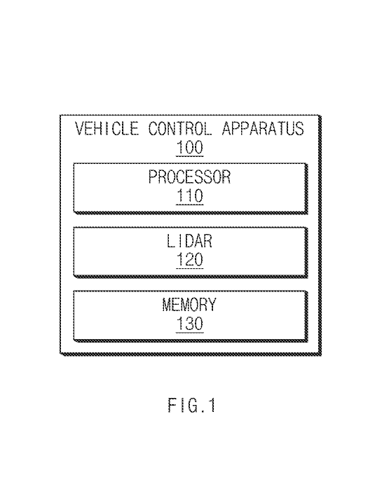

FIG. 1 shows an example of an overall system for automatically recognizing an object and controlling a vehicle for the purpose of autonomous driving, according to an example of the present disclosure.

Referring to FIG. 1, a vehicle control apparatus 100 according to an example of the present disclosure may be implemented inside or outside a vehicle, and some of components included in the vehicle control apparatus 100 may be implemented inside or outside the vehicle. At this time, the vehicle control apparatus 100 may be integrated with internal control units of a vehicle and may be implemented with a separate device so as to be coupled with control units of the vehicle by means of a separate connection means. For example, the vehicle control apparatus 100 may further include components not shown in FIG. 1.

The vehicle control apparatus 100 according to an example may include a processor 110, a LiDAR 120, and a memory 130. The processor 110, the LiDAR 120, or the memory 130 may be electronically and/or operably coupled with each other by an electronical component including a communication bus.

Hereinafter, the fact that pieces of hardware are coupled operably may include the fact that a direct and/or indirect connection between pieces of hardware is established by wired and/or wirelessly such that second hardware is controlled by first hardware among the pieces of hardware.

Although different blocks are shown, an example is not limited thereto. For example, some of the pieces of hardware in FIG. 1 may be included in a single integrated circuit including a system on chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to an example may include hardware for processing data based on one or more instructions. For example, the hardware for processing data may include the processor 110. For example, the hardware for processing data may include an arithmetic and logic unit (ALU), a floating point unit (FPU), a field programmable gate array (FPGA), a central processing unit (CPU), and/or an application processor (AP). The processor 110 may include the architecture of a single-core processor, or may include the architecture of a multi-core processor including a dual core, a quad core, a hexa core, or an octa core (e.g., depending on the computational complexity of perception models, route planning, or control logic, etc.).

According to an example, the processor 110 may include at least one of a graphic processing unit (GPU), or a neural processing unit (NPU), or any combination thereof. For example, the GPU may be referred to as a “visual processing unit (VPU)”. For example, the NPU may be referred to as a “neural network processing unit”.

The vehicle control apparatus 100 according to an example may include a depth sensor for detecting an external object. For example, the depth sensor for detecting an external object may include at least one of a time of flight (ToF) sensor, the LiDAR 120, a structured light sensor, an ultrasonic sensor, an infrared sensor, radio detection and ranging (RADAR), or an optical distance sensor, or any combination thereof (e.g., combining LiDAR and RADAR to improve robustness in low-visibility conditions, etc.). Hereinafter, for convenience of description, descriptions will focus on LiDAR.

The vehicle control apparatus 100 according to an example may include the LiDAR 120 that obtains a plurality of points based on a pulse laser signal. For example, the LiDAR 120 may obtain datasets obtained by identifying objects surrounding the vehicle control apparatus 100 (or a vehicle including the vehicle control apparatus 100). For example, the LiDAR 120 may identify at least one of a location of the surrounding object, a movement direction of the surrounding object, or the speed of the surrounding object, or any combination thereof based on the pulse laser signal emitted from the LiDAR 120 being reflected and returned by the surrounding object (e.g., a nearby vehicle, a pedestrian, a tree, or a building, etc.).

For example, the LiDAR 120 may obtain datasets for expressing an external object in the space defined by an x-axis, a y-axis, and a z-axis based on a pulse laser signal reflected from surrounding objects. For example, the LiDAR 120 may obtain datasets including a plurality of points in the space, which is formed by the x-axis, the y-axis, and the z-axis, based on receiving the pulse laser signal at a designated period (e.g., every 100 milliseconds, every sensor frame, or at a refresh rate of 10 Hz, etc.). For example, the plurality of points may include points representing an external object within a three-dimensional virtual coordinate system. The three-dimensional virtual coordinate system may include at least one of a vehicle coordinate system, or a LiDAR coordinate system, or any combination thereof. However, an example of the three-dimensional virtual coordinate system is not limited to those described above (e.g., it may include a world coordinate system or a map-based coordinate system, etc.).

The memory 130 of the vehicle control apparatus 100 according to an example may include a hardware component for storing data and/or instructions that are to be input and/or output to the processor 110 of the vehicle control apparatus 100. For example, the memory 130 may include a volatile memory including a random-access memory (RAM), and/or a non-volatile memory including a read-only memory (ROM).

For example, the volatile memory may include at least one of a dynamic RAM (DRAM), a static RAM (SRAM), a cache RAM, or a pseudo SRAM (PSRAM), or any combination thereof. For example, the non-volatile memory includes at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof (e.g., depending on cost, size, write endurance, or access speed, etc.).

One or more instructions indicating an arithmetic operation and/or an operation to be performed on data by the processor 110 of the vehicle control apparatus 100 may be stored in the memory 130 of the vehicle control apparatus 100. A set of one or more instructions may be referred to as a “program”, “firmware”, an “operating system”, a “process”, a “routine”, a “sub-routine”, and/or an “application”.

Hereinafter, the fact that an application is installed in the vehicle control apparatus 100 may mean that the one or more instructions provided in a form of an application are stored in the memory 130, and may mean that one or more applications are stored in a format (e.g., a file with an extension specified by the operating system of the vehicle control apparatus 100) executable by the processor 110 of the vehicle control apparatus 100 (e.g., a binary executable file, or a compiled library, etc.).

For example, the memory 130 may include a first neural network model for detecting an object. For example, the memory 130 may include a second neural network model for outputting the types of the plurality of points obtained by the LiDAR 120, and/or scores of the plurality of points (e.g., object class scores or distance likelihoods, etc.).

In an example, the processor 110 may obtain at least one of a first virtual box representing a target object, or a first class representing the type of the target object, or any combination thereof based on the plurality of points obtained through the LiDAR 120 and the first neural network model stored in the memory 130.

For example, the processor 110 may obtain at least one of the first virtual box representing the target object, or the first class representing the type of the target object, or any combination thereof based on inputting the plurality of points to the first neural network model. For example, the first neural network model may include an object detection model (e.g., a 3D bounding box detector or a center-based detection network, etc.). For example, the target object may include an external object placed within a specified distance from the vehicle control apparatus 100 (or a host vehicle including the vehicle control apparatus 100) (e.g., within a 50-meter range in the forward direction, etc.). For example, the target object may include an object that is identified by the vehicle control apparatus 100 and is continuously tracked. For example, the type of the target object may include a plurality of types for classifying the target object. For example, the type of the target object may include at least one of a first type representing the ground, or a second type representing a type different from the ground, or any combination thereof. The type of the target object is not limited to the examples described above. For example, the type of the target object may include, but is not limited to, at least one of a third type representing a person, or a fourth type representing a vehicle, or any combination thereof (e.g., a bicycle, a traffic cone, a tunnel wall, or a construction sign, etc.).

In an example, the processor 110 may obtain at least one of first partial points corresponding to at least part of the target object among the plurality of points, or a second class identified by the first partial points and representing the type of the target object, or any combination thereof based on the plurality of points and a second neural network model. For example, the second neural network model may include a segmentation model (e.g., a range-view CNN, a point-based classifier, or a sparse voxel network, etc.).

For example, the second neural network model may include a neural network model for obtaining the types of the plurality of points and scores of the plurality of points (e.g., softmax outputs, probability heatmaps, or class activation scores, etc.).

For example, the processor 110 may obtain the first partial points corresponding to at least part of the target object among the plurality of points based on inputting the plurality of points to the second neural network model. For example, the processor 110 may identify the types of the plurality of points based on inputting the plurality of points to the second neural network model. For example, the processor 110 may obtain the first partial points corresponding to at least part of the target object among the plurality of points based on the type of each of the plurality of points (e.g., classifying some points as belonging to a vehicle, pedestrian, or roadside object, etc.).

In an example, the processor 110 may perform a first specified algorithm on the plurality of points. For example, the processor 110 may perform the first specified algorithm for classifying the type of each of the plurality of points on the plurality of points, for example, within the LiDAR data frame. For example, the processor 110 may classify second partial points corresponding to a specified type among the plurality of points. For example, the specified type may include a type representing the ground (e.g., pavement, crosswalks, or flat surfaces, etc.).

For example, on the basis of performing the first specified algorithm on the plurality of points, the processor 110 may obtain (or identify) the first partial points by classifying the second partial points corresponding to the specified type and excluding the second partial points from the plurality of points (e.g., separating above-ground structures from terrain, etc.).

In an example, the processor 110 may obtain at least one of a partial class for obtaining the second class, or a score of each of the plurality of points, or any combination thereof based on inputting the plurality of points to the second neural network model. For example, the processor 110 may obtain the partial class and the score of each of the plurality of points based on inputting the plurality of points to the second neural network model. For example, the partial class may include classifying the plurality of points based on an arbitrary type (e.g., tree, vehicle, pedestrian, or unknown, etc.).

For example, the processor 110 may fuse the partial class, the score of each of the plurality of points, and the second partial points (e.g., for joint feature enhancement or confidence weighting, etc.). For example, the processor 110 may perform clustering based on fusing the partial class, the score of each of the plurality of points, and the second partial points. For example, the clustering may include grouping the first partial points corresponding to at least part of the target object (e.g., to generate an instance-level region for bounding box generation, etc.).

For example, the processor 110 may obtain a point cloud for generating a second virtual box based on the first partial points. For example, the processor 110 may obtain the point cloud based on grouping the first partial points (e.g., using spatial proximity, density thresholding, or Density-Based Spatial Clustering of Applications with Noise (DBSCAN), etc.).

For example, the processor 110 may generate the second virtual box, which is different from the first virtual box and represents the target object, based on the point cloud. For example, the second virtual box may include a box including at least some of the first partial points (e.g., tightly fitted to the object's spatial extent, etc.).

For example, the processor 110 may identify a heading direction indicating a traveling direction of the target object based on at least one of the first partial points, or the point cloud, or any combination thereof (e.g., using temporal point shifts or bounding box orientation, etc.).

For example, the processor 110 may identify the location of the second virtual box in the virtual coordinate system based on at least one of the first partial points, or the point cloud, or any combination thereof (e.g., by computing the centroid of the clustered points, using a bounding box anchor, or referencing vehicle-relative coordinates, etc.). For example, the processor 110 may identify the size of the second virtual box based on at least one of the first partial points, or the point cloud, or any combination thereof (e.g., by estimating width, height, and depth based on point dispersion or statistical spread, etc.). For example, the processor 110 may identify the second class based on at least one of the first partial points, or the point cloud, or any combination thereof (e.g., classifying as car, pedestrian, traffic cone, or unknown, etc.). For example, the processor 110 may identify at least one of a heading direction indicating a traveling direction of the target object, a location of a second virtual box in a virtual coordinate system, a size of the second virtual box, or a second class, or any combination thereof based on at least one of the first partial points, or the point cloud, or any combination thereof (e.g., to aid in trajectory prediction, collision risk estimation, or classification confidence, etc.). For example, the processor 110 may identify the heading direction of a bounding box based on at least one of the first virtual box, the first class, the heading direction of the second virtual box, the location of the second virtual box, the size of the second virtual box, or the second class, or any combination thereof (e.g., by tracking box orientation over time, using direction vectors, or aligning with lane markings, etc.). For example, the processor 110 may identify the location of a bounding box in a virtual coordinate system based on at least one of the first virtual box, the first class, the heading direction of the second virtual box, the location of the second virtual box, the size of the second virtual box, or the second class, or any combination thereof (e.g., using Kalman filtering, relative coordinate mapping, or GPS reference data, etc.). For example, the processor 110 may obtain a third class representing the type of the target object corresponding to the bounding box based on at least one of the first virtual box, the first class, the heading direction of the second virtual box, the location of the second virtual box, the size of the second virtual box, or the second class, or any combination thereof (e.g., refining classification using fusion from multiple frames, object hierarchy rules, or semantic context, etc.). For example, the processor 110 may obtain at least one of the heading direction of the bounding box, the location of the bounding box in the virtual coordinate system, or the third class indicating the type of the target object corresponding to the bounding box, or any combination thereof based on at least one of the first virtual box, the first class, the heading direction of the second virtual box, the location of the second virtual box, the size of the second virtual box, or the second class, or any combination thereof (e.g., for generating object tracks, scene graphs, or vehicle control cues, etc.).

For example, the processor 110 may assign a first identifier to the second virtual box for tracking the second virtual box (e.g., a unique ID based on timestamp, class, or location hash, etc.). For example, the processor 110 may assign a second identifier corresponding to the first identifier to a bounding box (e.g., to maintain identity consistency between detection and tracking outputs, etc.).

For example, the processor 110 may track the bounding box by using the second identifier. For example, the processor 110 may track a target object based on identifying, in a plurality of frames, a plurality of bounding boxes including the bounding box to which the second identifier is assigned (e.g., through temporal association or object re-identification, etc.). For example, because the second identifier is an identifier assigned to the bounding box corresponding to the target object, the processor 110 may track the target object by identifying a plurality of bounding boxes, to which the second identifier is assigned, in a plurality of frames (e.g., over multiple sensor cycles or time steps, etc.).

In an example, the processor 110 may output the bounding box corresponding to the target object based on at least one of the first virtual box, the first class, the first partial points, or the second class, or any combination thereof (e.g., as a hexahedral 3D box, 2D projected box, or directional polygon, etc.). For example, a bounding box may include an example of the target object expressed in a virtual coordinate system in the form of a hexahedron (e.g., defined by eight corner points in 3D space, etc.).

Hereinafter, operations performed by a CPU, a GPU, and/or an NPU included in the processor 110 are briefly described.

In an example, the processor 110 may include at least one of the CPU, the GPU, or the NPU, or any combination thereof. For example, at least one of the GPU, or the NPU, or any combination thereof may obtain the first virtual box and the first class based on the first neural network model (e.g., a region proposal network, transformer-based model, or YOLO-like detector, etc.). For example, at least one of the GPU or the NPU may obtain the first virtual box and the first class. For example, at least one of the GPU, or the NPU, or any combination thereof may obtain a score for each of the plurality of points and a partial class for obtaining the second class based on the second neural network model. For example, at least one of the GPU or the NPU may obtain the score of each of the plurality of points and the partial class for obtaining the second class based on the second neural network model (e.g., probability distributions over semantic labels, etc.). For example, the CPU may classify the second partial points corresponding to a specified type among the plurality of points based on performing the first specified algorithm for classifying each type of the plurality of points (e.g., such as distinguishing ground, non-ground, or noise points, etc.).

As described above, the vehicle control apparatus 100 according to an example may include at least one processor 110. The vehicle control apparatus 100 may accurately detect the target object by detecting the target object by using the at least one processor 110. Furthermore, the vehicle control apparatus 100 may reduce the load on each processor by performing parallel processes (e.g., enabling real-time LiDAR segmentation and object tracking, etc.).

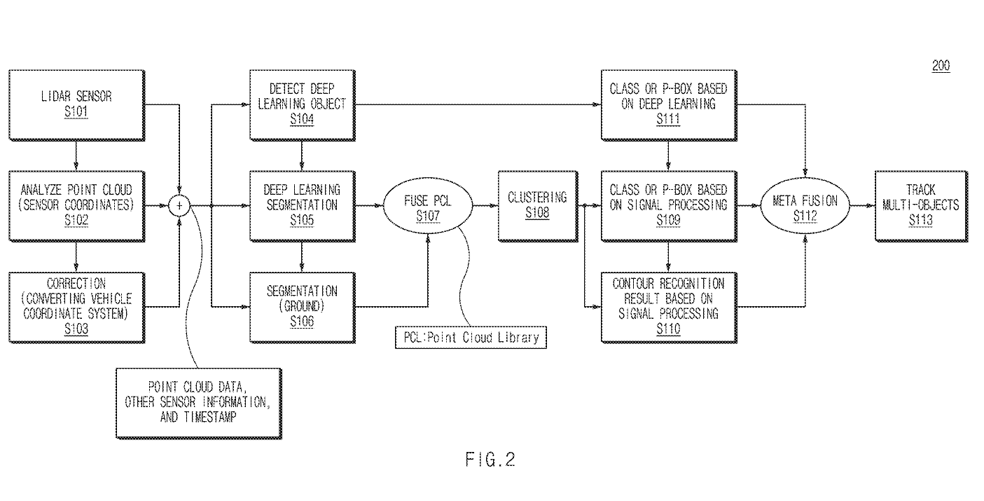

In the meantime, before referring to FIG. 2, for a general understanding of AI object recognition according to an example of the present disclosure, descriptions related to LiDAR-based object recognition is added as follows.

The object recognition process by the LiDAR 120 and the AI module goes through three stages: pre-processing, segmentation, and tracking. For example, AI module may include and execute one or more AI models (e.g., neural networks) for preprocessing, segmentation, and tracking (e.g., detecting road surfaces, identifying vehicle outlines, or following pedestrian movement, etc.).

An object recognition system 1000 according to an example of the present disclosure goes through a pre-processing process before executing an object recognition function. The pre-processing may include an operation of removing points forming the ground based on laser sensing data (i.e., raw data not processed) input from the LiDAR 120. Because the laser beam reflected from the ground may be misrecognized as though there is an object on the ground, a process of distinguishing between the ground and non-ground may be performed in the pre-processing stage. As needed, the process may also be performed in the segmentation stage.

For example, in AI object recognition, the pre-processing may be understood as a process in which an image processing tool of the AI module in the processor 110 removes noise from a LiDAR point cloud image and reduces the total number of points being present in the LiDAR point cloud image through a voxel downsampling technique to improve computational efficiency.

For reference, the LiDAR point cloud image may also be displayed in a bird’s eye view (BEV) mode. When a LiDAR map is created to resemble the scene as seen through a bird’s eye when a bird watches a city center while a bird flies overhead, such LiDAR map is called a BEV image (e.g., top-down views showing roads, vehicles, curbs, or crosswalks, etc.).

In other words, as described above, the LiDAR 120 generates a point for each of the numerous laser signals and calculates a distance to the point, by sending a laser beam out into environments and recording the time at which the laser beam is reflected from an object outside the environments and then is returned. The processor 110 may create a real-time LiDAR map of the surrounding environment as a BEV-type 3D map, or as a 2D map as needed (e.g., for simplified planning, navigation, or pedestrian zone detection, etc.), by repeatedly sending out a lot of laser beams in this way.

The lines or areas that appear in black and white on a LiDAR point cloud map are actually composed of countless points (each of the points is generated by the laser beam of the LiDAR 120), which is why the LiDAR sensing image is also called the LiDAR point cloud image. Of course, for example, when an RGB-D (Red, Green, Blue – Depth) sensor and a LiDAR sensor are combined, the LiDAR point cloud image may be recreated in color (e.g., to distinguish road markings, traffic signs, or construction cones, etc.).

It is difficult for humans to perceive objects with a lot of points in the LiDAR point cloud image. However, when comprehensively looking at a point cloud from a BEV perspective or in a method such as a two-dimensional plan, humans may roughly guess what the surroundings of the vehicle currently driving autonomously look like. Furthermore, for example, various types of objects (e.g., vehicles, buses, pedestrians, street trees, traffic signs, or a construction cone, etc.) that are present in the LiDAR point cloud image may be recognized. In an AI image recognition technology, these things or people are called objects. Each object may be classified into classes belonging to a group with specific characteristics, such as a vehicle class or a bus class, pedestrian class, traffic light class, or barrier class, etc.

Identifying a class of an object such as a vehicle class, a bus class, and the like in the LiDAR point cloud image requires the help of a deep AI neural network. To find objects in the LiDAR point cloud image through an AI neural network and to identify classes of the objects, AI training needs to be performed first.

For example, a dataset called PANDASET^{™} includes over 48,000 camera images (mostly taken in the Silicon Valley area in the United States) and over 16,000 LiDAR scan images, which are annotated with 28 classes, including pedestrians, passenger cars, bicycles, construction site signs, and traffic signs.

Moreover, the LiDAR point cloud image may be visualized to suit a user’s desired options by using point cloud task tools such as Open3D™. Because the LiDAR 120 is capable of detecting a distance, 3D LiDAR images may be realistically reproduced in visual processing with Open3D^{™}, for example, in a method in which objects farther away are colored in dark blue, and objects closer are colored in light blue (e.g., rendering distant trees in blue and nearby vehicles in bright blue, etc.).

Furthermore, as mentioned above, the original LiDAR image (i.e., raw data) may be pre-processed by applying a technique called voxel (three-dimensional pixel) downsampling to the LiDAR point cloud image. Here, the voxel refers to a cube-shaped 3D pixel. The voxel downsampling is a technique for reducing the number of points in the LiDAR point cloud without requiring excessive AI computation while the structure of the various objects in the cloud is preserved.

In the meantime, for example, the LiDAR 120 emits ‘m’ laser beams ‘n’ times during one scan cycle. In this case, scan values of the laser beams that collide with an external object and return form an m×n matrix. Data of the m×n matrix is called a range image. Each point constituting the LiDAR point cloud image includes depth (i.e., range) information, and also includes the intensity, azimuth, and inclination of the returned laser pulse (e.g., reflectivity, return number, or time-of-flight, etc.) and other additional information. For range images, AI training is possible by using large datasets such as Waymo™ Open Dataset (WOD), for example.

In short, range view (RV) is a technique that converts a three-dimensional point cloud into a two- to two-and-a-half-dimensional scene, and represents the converted result as a LiDAR three-dimensional map that humans is capable of intuitively understanding like an analog painting instead of a lot of dots (e.g., as a panoramic image showing lane boundaries and obstacles in a simplified layout, etc.). In the range view image, the 3D LiDAR point cloud image includes 2D coordinates. However, the 3D laser-related information (an angle, an inclination, intensity, or the like) recorded when the range image is obtained is not discarded. When one coordinate of one 2D axis is obtained by applying a variable of a width to coordinates (x, y) among coordinates (x, y, z) of the 3D LiDAR image, and the other coordinate of the other 2D axis is obtained by applying a variable of a height and range image information indicating a range (depth) to coordinate (z), a 2D range view image is created (e.g., mapping lateral position to image width and vertical angle or elevation to image height, etc.).

In addition, the AI algorithm according to an example of the present disclosure may include a convolutional neural network (CNN). The CNN is an AI training module frequently used to extract features (or feature points) from image data (e.g., edges, corners, textures, or object outlines, etc.). To this end, there are commercially available datasets composed of tens of thousands of images. Currently, the CNN includes a version capable of processing images from 1D to 3D (e.g., 1D for signal patterns, 2D for camera images, or 3D for LiDAR voxel grids, etc.). That is, results of a range view image processing tool are trained by the CNN to perform a function of helping AI accurately recognize an object in an image.

Because an object around an autonomous vehicle is finally recognized by a machine, generation of a ground truth (GT) bounding box on the aforementioned LiDAR map is also an important process in object recognition. In machine learning, the GT is a term used to indicate an original value or an actual value of data to be trained by the AI (e.g., the real position of a pedestrian, car, or traffic cone, etc.). It may be a type of image annotation applied to the LiDAR point cloud image as a bounding box usually with a box-shaped boundary.

That is, to recognize an object, the AI module fetches a label and then groups various objects (e.g., grouping multiple detected vehicles into a vehicle class or pedestrians into a pedestrian class, etc.). Of course, an interval between 3D data points used to output a GT bounding box may also be set. One GT bounding box may be set to include 50 to 1000 LiDAR cloud points (e.g., depending on the object’s size or scan density, etc.).

Of course, such the GT annotation is not present in raw data captured by a sensor such as the LiDAR 120 while a vehicle is driving. The processor 110 needs to recognize a target belonging to various classes such as road signs, crosswalks, pedestrians, another vehicle, a center line, or a guardrail, etc., as an object. The GT annotation is a means used to measure object recognition errors by comparing the object determination results recognized by the AI algorithm of the processor 110 with an actual object and to sometimes evaluate AI performance. The GT bounding box applied to an original image in an annotation form may be set manually by a user, but there are also commercially available GT calculation tools, such as grid-striding (e.g., dividing a space into grid cells and labeling each cell’s contents, etc.).

When an AI object recognition module is executed, the predicted bounding box may also be identified. The result recognized by the processor 110 as an object of a specific class from the original image data obtained from the LiDAR sensor 120 is displayed in the shape of another bounding box similar to the GT bounding box. The predicted bounding boxes, unlike GT bounding boxes, are the computational results of autonomous driving AI. The predicted bounding box may match the GT bounding box, but there may be an area that the predicted bounding box does not match or overlap the GT bounding box at all (e.g., due to sensor noise, occlusion, or misclassification, etc.).

For reference, only the predicted bounding boxes may not definitively determine whether an object of a specific class is actually present at a specific location, and thus the predicted bounding boxes are usually called probability boxes (P-Boxes) or predicted bounding boxes.

For example, segmentation processing performed after pre-processing refers to displaying a specific part of a road (e.g., a traffic light) in red and the rest (an asphalt road) in blue (e.g., for class-based color labeling, etc.). Clustering a point cloud into specific groups and generating P-Box may also be performed at the segmentation stage. For reference, there is also a technique called cluster expansion. Here, an expansion target may include a cluster from a seed point to all points within an epsilon distance (a minimum distance for forming a cluster) (e.g., expanding a group of adjacent car-surface points into a full vehicle object, etc.).

During the segmentation processing, P-Box creation and clustering based on the point cloud are performed. For example, the AI network performing segmentation is used to obtain a point label from the LiDAR sensor 120 (e.g., labeling a point as road, curb, or obstacle, etc.).

To solve a ground recognition error occurring during the segmentation, the present disclosure proposes a “rule-based” ground recognition and label fusion technique. Any of various techniques such as slope-based ground recognition, grid-based ground recognition, or other non-planar-based ground recognition may be applied as the ground recognition algorithm (e.g., for detecting curved ramps, uneven terrain, or multi-elevation surfaces, etc.). However, in an example of the present disclosure, it is proposed that the slope-based ground recognition technique is to be adopted when the ground inside a tunnel is recognized.

For reference, semantic segmentation refers to a task of assigning a unique class label to each point in the point cloud generated by the LiDAR 120. In the LiDAR image processing technology, the semantic segmentation is a technology that finds and uses meaningful information from LiDAR data for object recognition and scene reproduction, which are necessary for implementing autonomous driving (e.g., identifying roads, sidewalks, vehicles, or vegetation, etc.). Various semantic segmentation AI models such as a projection-based method, a point-based method, and a sparse convolution-based method may be applied. For example, the semantic segmentation result may be the result of AI computation performed by the processor 110 and NVIDIA DRIVE™ AGX system. With this configuration, for example, various colors may be added to the LiDAR point cloud image (e.g., coloring vehicles in red, pedestrians in yellow, or road surfaces in gray, etc.).

After the segmentation process as above, the LiDAR image goes through a post-processing process. The post-processing refers to converting point cloud data into a 3D map or a model, to extract meaningful information for autonomous driving. The post-processing also includes a process of finally removing noise and errors from a LiDAR point cloud image, recognizing an object such as a vehicle or a pedestrian from the point cloud, and attaching and registering a unique identifier to point cloud information as necessary (e.g., for object tracking, localization, or scene mapping, etc.).

Based on the description of FIG. 1 above, descriptions will be given with reference to FIG. 2. FIG. 2 shows an example of an operation process 200 of an autonomous driving LiDAR perception software architecture-related system 1000, according to an example of the present disclosure.

S101 shows a process of processing optical data into packet data by using the LiDAR sensor 120. That is, an input of S101 is optical data, and an output thereof is packet data. In S101, an operation is performed to convert data detected by a LiDAR sensor information optical system into digital information (e.g., converting reflected laser pulses, intensity values, time-of-flight data, or wavelength information, etc.).

In S102, an operation is performed to convert packet data of a packet data point cloud into point cloud data in a sensor coordinate system. An output of S102 is a point cloud, and the output is point cloud data generated based on the sensor coordinate system. S102 is preferably computed by a GPU processor. That is, an input to S102 is LiDAR packet data and sensor meta information (e.g., calibration parameters, scanning angle, timestamp data, or rotation frequency, etc.).

S103 is a process of correcting a point cloud sensor coordinate system version to a point cloud based on a vehicle coordinate system, and is a procedure of removing dependency on vehicle types in object recognition (e.g., aligning the sensor coordinate system with a vehicle body coordinate system, correcting yaw/pitch/roll offsets, or compensating for mounting position variations, etc.). S103 is preferably computed by the GPU processor.

S104 is a process of detecting objects from the point cloud based on deep learning. For example, an output of S104 may be a LiDAR data bounding box, and class recognition results and a bounding box including heading information may be output through an AI network that recognizes a class (e.g., identifying vehicles, pedestrians, bicycles, or roadside obstacles, etc.). S104 is preferably computed by the GPU processor.

In S111, the output of S104 is converted into class information and P-Box information derived based on deep learning. An input for S104 includes point cloud data (sensor/vehicle), sensor information, and timestamp information. As a result, an output of S111 is class recognition results (e.g., whether it is a dynamic object, a static object, a road sign, or vegetation, etc.) and box information calculated based on deep learning.

In the meantime, in S105, LiDAR data is input and then output as class classification information and related score information. That is, score calculation results and a class for each point are output through the above-described segmentation network (e.g., per-point classification into ground, vehicle, pedestrian, or building, etc.). S105 is preferably computed by the GPU processor. An input for S105 includes point cloud data (sensor/vehicle), sensor information, and timestamp information.

In S106, ground point classification is performed after the LiDAR data is input. S106 is not deep learning, but ground point classification based on signal processing. This task may be performed on a point-by-point basis, and may be configured to perform binary classification (e.g., ground vs. non-ground, drivable vs. non-drivable, or road surface vs. obstacle surface, etc.). An input for S106 includes point cloud data (sensor/vehicle), sensor information, and timestamp information.

In S107, point-specific class and ground recognition results are input, and a class and a score are output. In other words, it is understood that S107 is a process of reinforcing ground points by fusing the outputs of S105 and S106 to secure ground recognition performance of ultra-short-distance data. This is a process of fusing ground data by a point cloud library (PCL) (e.g., combining segmentation class labels with ground elevation maps, slope constraints, or surface smoothness, etc.).

In S108, LiDAR data and class information are input. This is output as cluster ID and cluster-related information (e.g., a size of a cluster, the average number of points included in the cluster, density of points in the cluster, or the centroid location, etc.). That is, an operation of identifying a cluster by utilizing point characteristics and distance information is performed in S108. For example, an output of S108 is a cluster ID assigned to each point.

In S109, LiDAR data and cluster ID information are input, and P-Box and related class information are output. A class and a bounding box including a 3D position, a size, and a heading of the P-Box are output based on signal processing. An output of S109 is class recognition results (e.g., whether it is a dynamic object, a static object, a cyclist, or a roadside structure, etc.) and box information calculated based on signal processing.

In S110, LiDAR data and cluster ID information are input, and contour information about a recognition target object is output. An output of S110 is the contour recognition result calculated based on signal processing (e.g., outlining a vehicle silhouette, pedestrian shape, tree contour, or barrier edge, etc.).

In S112, the results of S109, S110, and S111 are meta-fused. That is, on the basis of the contour information, class, and bounding box obtained based on signal processing, the meta-fusion is performed in S112 on the class information and the bounding box output based on deep learning (e.g., combining signal-processing contours with deep-learning bounding boxes, merging static/dynamic classification from both pipelines, or resolving inconsistencies between box dimensions, etc.).

In S113, a multi-object tracking ID is generated based on the bounding box and the class information (e.g., assigning unique IDs to cars, pedestrians, bicycles, or roadside objects across sequential frames, etc.).

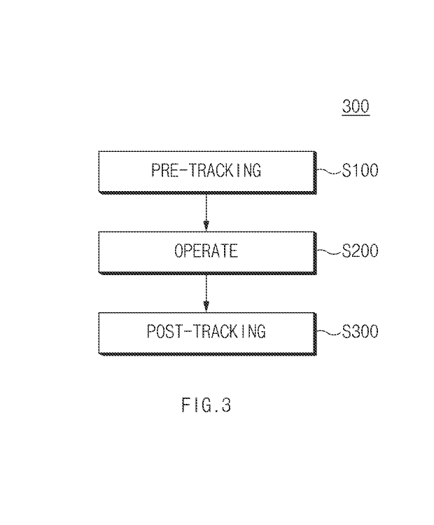

FIG. 3 shows an example of an algorithm 300 for tracking an object based on an autonomous driving sensor and an AI, according to an example of the present disclosure (e.g., a LiDAR sensor, a camera sensor, a radar sensor, or a fusion of multiple sensors, etc.).

Referring to FIG. 3, in a pre-tracking stage of S100, shape information (e.g., a clustered P-Box, a heading, a shape, clustered point information, a contour of the object, or a bounding polygon, etc.) of a P-Box is received, and information about a meta object and information about a host vehicle are selected and output based on a priority (in particular, for the meta object). An output of S100 may also include the result of determining an object called a bush (e.g., roadside bushes, hedges, small trees, or vegetation clumps, etc.).

For example, in S100, input information is converted into meta information used in the object tracking system 1000 according to an example of the present disclosure, and input information exceeding the number of tracking items capable of being processed is filtered out based on the priority (e.g., selecting moving vehicles first, then pedestrians, bicycles, or static objects, etc.). At the same time, in S100, host vehicle information is updated (e.g., speed, acceleration, lane position, or yaw rate, etc.) and the meta object determined as a bush is selected.

An input in S200 is host vehicle information and the meta object information generated in S100. An output thereof is tracking channel update results associated with the meta object, new tracking channel results, and driving environment information (e.g., road boundaries, clustering of a tubular marker, crosswalks, lane dividers, or curbs, etc.).

In S200, information updated based on tracking channels is processed, driving environment information is updated, meta verification information is updated to improve clustering errors, and the heading accuracy related to the P-Box is improved, while various pieces of noise such as environmental noise (e.g., raindrops, snowflakes, exhaust plumes, reflective road signs, or roadside bushes, etc.) are removed.

Furthermore, in S200, while tracking association information is updated, the tracking channel is associated with the meta object. When tracking channel information is updated, the tracking channel information is updated based on the associated meta object information. Updating false track management information is a process of removing a false track caused by exhaust gas or crosstalk noise (e.g., exhaust plumes, reflections from glass buildings, metallic roadside objects, or multipath artifacts, etc.).

In S300, a tracking channel, a meta object linked to the tracking channel, and clustering point information are input. That is, in S300, duplicate and separated results between tracking channels are merged, and the tracking channel information is verified. Furthermore, duplicated or separated tracking channels may be processed by updating determination information about moving/stationary objects and updating the tracking channel management information, thereby improving the determination performance of a sensor boundary region (e.g., regions at the edge of LiDAR range, blind spots near large vehicles, intersections, or tunnel entrances, etc.). In S300, tracking reliability information is also calculated, and the reliability score of each element of the tracking information is added to the meta information (e.g., weighting based on sensor confidence, object stability, occlusion likelihood, or classification accuracy, etc.) is updated.

In S300, tracking channel verification information is updated to verify tracking channel information while false tracks and misrecognition performance are improved. Furthermore, in S300, memory tracking processing information is updated, thereby securing tracking stability and improving object recognition and tracking performance, such as noise removal (e.g., maintaining a track of an occluded vehicle, preserving a pedestrian hidden by a bus, retaining a bicycle temporarily behind a truck, or compensating for sensor dropout, etc.). In S300, output information is generated. The output information may be an output verified by compensating for the delay time from a sensing time point to an output time point (e.g., compensating for 50 ms LiDAR scan delay, 100 ms processing delay, network latency, or synchronization offset, etc.).

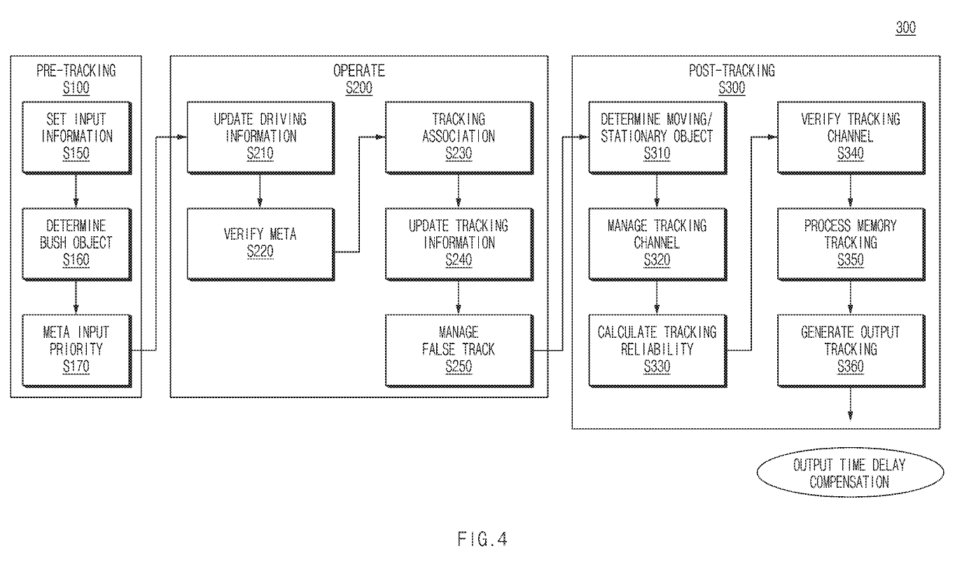

FIG. 4 shows an example of an algorithm 300 for tracking an object based on an autonomous driving sensor and an AI together with sub-processes thereof, according to an example of the present disclosure.

Referring to FIG. 4, in S150, which is a sub-process of S100, the input time of an autonomous driving sensor, host vehicle information, and bounding box information (i.e., information about a location, a shape, a class, or a heading) are input, and meta object information is output (e.g., object ID, motion status, confidence score, or recognition timestamp, etc.).

In S150, time information is updated. After the left and right LiDAR sensors 120 are paired, time difference information from a previous time point to a current time point is updated. When vehicle information is updated, the longitudinal speed, transverse speed, and angle information of a host vehicle are updated (e.g., yaw rate, steering angle, pitch angle, or roll angle, etc.). When input box information is set, meta object information is generated based on information about a bounding box, a heading, a class, object dimensions, or contour details, etc.

In S160, meta object information and LiDAR point cloud data generated in S150 are input. That is, in S160, the clustered point information of the meta object is input. An output of S160 is meta object information determined as a bush (e.g., roadside vegetation, hedges, small trees, or grass clusters, etc.). This is the result of an algorithm that determines whether an object is a bush, and the meta object information determined to be a bush is output.

In S170, the meta object information is input, and a meta object selected preferentially is output. As described above, if the number of input meta objects exceeds the number of output tracking channels, priorities of meta objects are determined (e.g., based on distance, class type, movement status, or potential collision risk, etc.), and the number of meta objects is limited (or filtered) to the predetermined number so as to be output.

In S210, which is a sub-process of S200, meta object information and point cloud information (i.e., clustered point information of the meta object) are input. For example, information related to road boundaries, information about clusters of a tubular marker, information about vehicles approaching the host vehicle, pedestrian positions, or obstacles in adjacent lanes, etc. are output. For example, in S210, driving environment information is updated, and includes information about road boundaries, the clustering of a tubular marker, and the selection of Closest In-Path Vehicle (CIPV) (e.g., the nearest leading car, motorcycle, or bus directly ahead, etc.).

In S220, meta object information and point cloud information (i.e., clustered point information of the meta object) are input, and the above-mentioned meta object determined as under-segmentation is output (e.g., two vehicles incorrectly recognized as a single large cluster, multiple pedestrians grouped as one object, or lane markers merged with a curb, etc.). In addition, the meta object from which lane/curb noise are removed is output, and heading verification results of the meta object are also output (e.g., correcting heading drift, verifying orientation using temporal consistency, or adjusting based on motion vectors, etc.).

That is, in S220, meta input information is verified. A process of separating a LiDAR point-based under-segmentation phenomenon and removing a LiDAR dynamic object and lane/curb noise is performed (e.g., filtering moving shadows, removing spurious reflections from guardrails, or separating overlapping cars at intersections, etc.). Of course, meta object heading is also verified to stabilize the LiDAR tracking object (e.g., recalculating orientation for turning vehicles, correcting occluded bicycles, or smoothing heading for pedestrians, etc.).

In S230, the meta object and the tracking channel information are input, and the update result of tracking channel prediction information, the result of tracking-associated tracking channel, and the result of creating a new tracking channel are output. Also, in S230, some tracking channels may be deleted, and a tracking channel determined to be a false track in the previous frame is to be deleted (e.g., tracks of exhaust plumes, roadside bushes, or multipath reflections, etc.). Moreover, in S230, a host vehicle information tracking channel is updated, and host vehicle information at a current time point is updated for each tracking channel (e.g., lane position, acceleration state, or braking input, etc.). Furthermore, in S230, the tracking channel location is predicted by predicting a tracking location of the previous frame as a location of the current time point (e.g., linear extrapolation, constant velocity prediction, or Kalman filtering, etc.).

Besides, in S230, the tracking association is determined, and S230 is a process of determining the association between the meta object and the tracking channel. When a new tracking channel is created, a meta object without the tracking association is created as a new tracking channel (e.g., a pedestrian entering the scene, a newly detected bicycle, or a parked car just becoming visible, etc.). In the meantime, a memory tracking target is also selected. The existing tracking channel, which is not associated with the meta object, is selected as a memory tracking target (e.g., temporarily occluded vehicles, partially hidden motorcycles, or stationary obstacles behind larger objects, etc.).

In S240, meta object information is input and the update result of tracking channel information is output. That is, a candidate group is first selected by calculating the connectivity between the tracking channel and the meta object (e.g., overlap ratio, distance threshold, velocity similarity, or heading alignment, etc.). A final candidate with the highest association is selected, and then the progression direction is selected. The progression direction of a box is selected based on the accumulated location information (e.g., lane-following direction, turning trajectory, or merging path, etc.). In S240, the location information of the meta object is identified through the extraction of the measured value speed, and location information and speed information are estimated through tracking filtering (e.g., Kalman filter, particle filter, or IMM filter, etc.). Depending on low-speed and high-speed driving conditions, different pieces of logic may be applied to a tracking heading information update (e.g., tighter updates for urban traffic, smoother updates for highway speeds, or adaptive thresholds for stop-and-go traffic, etc.). A tracking shape information update in S240 is performed only on tracks in a moving state by determining a sensor boundary region, occlusion, or the like for each width and length (e.g., vehicles partially cut off by sensor range, occluded pedestrians near buses, or truncated bicycles at road edges, etc.).

In S250, meta object information and point cloud information (i.e., clustered point information of a meta object) are input, and the determination result for a false track is output. The false track may be caused by exhaust fumes, mirror ghosting, road signs, or the like (e.g., exhaust plumes, reflective license plates, shiny glass windows, or metallic poles, etc.), and pieces of noise on roads are determined in S250.

Next, in S310, which is a sub-process of S300, meta object information and point cloud information (i.e., clustered point information of the meta object) are input, and state determination results regarding whether it is a moving/stationary object (e.g., moving car, stopped pedestrian, parked bicycle, or stationary traffic cone, etc.) is output.

That is, in S310, classification information is updated, and a moving/stationary state determination is performed. When a moving/stationary object is determined, the moving/stationary object may be determined by using a feature value-based score (e.g., speed magnitude, trajectory consistency, optical flow similarity, or point cloud displacement, etc.). If the speed of the moving object is greater than or equal to a specific speed threshold, the moving object may be determined to be in a moving state (e.g., 10 km/h, 20 km/h, or dynamically set thresholds, etc.). The tracking channel determined to be in a moving state may be maintained as the moving state even when the corresponding object (i.e., another vehicle) is stationary (e.g., vehicles at red lights, cars in congestion, or buses at a bus stop, etc.).

In S320, tracking channel information is input, and the result of deleting or merging overlapping tracking channels is output. That is, S320 is a process of selecting and deleting abnormal tracking channels and merging tracking channels when the tracking channels overlap each other (e.g., duplicate tracks of the same car, overlapping pedestrian detections, or separated segments of a large truck, etc.). When separate clustering information of the same object is used, a plurality of tracking channels are merged. The tracking channels of the same object that are separated at a sensor boundary reflect a portion, from which merged parts or duplicated parts are removed (e.g., two halves of a vehicle split at the sensor boundary, fragmented bicycles, or multiple segments of a bus, etc.).

In S330, tracking channel information is input, and tracking reliability results are output. That is, in S330, the reliability is calculated and updated. A reliability score is created by using a score obtained by adding the reliability of each tracking channel update function (e.g., association success, memory retention, false track removal, or heading verification, etc.) to the reliability of the meta object (e.g., classification confidence, point density, or stability of clustered points, etc.).

In S340, tracking channel information, associated meta objects, and clustering point information are input, and the verification results of the tracking channel are output. In S340, the tracking performance verification logic is updated; classification of moving objects is verified based on template matching (e.g., vehicle outlines, pedestrian silhouettes, or bicycle shapes, etc.); and, tracking channel information (a location, a speed, a heading, a shape, a contour, or a trajectory, etc.) is verified.

In S350, a memory tracking selection tracking channel is input, and a tracking channel maintenance result and a tracking channel deletion request are output. In other words, in S350, memory tracking may be performed, and a retention period may be limited and managed for each memory tracking type (e.g., short-term occlusion, long-term occlusion, or intermittent sensor loss, etc.).

In S360, sensing time information, processing time information, tracking channel information, or the like are input, and output information with the compensated time delay is output. That is, in S360, the logic for selecting a time compensation target is updated, and the delay time is compensated when output information is generated (e.g., compensating for 50 ms LiDAR rotation lag, 100 ms GPU processing delay, synchronization delay across sensors, or communication latency, etc.).

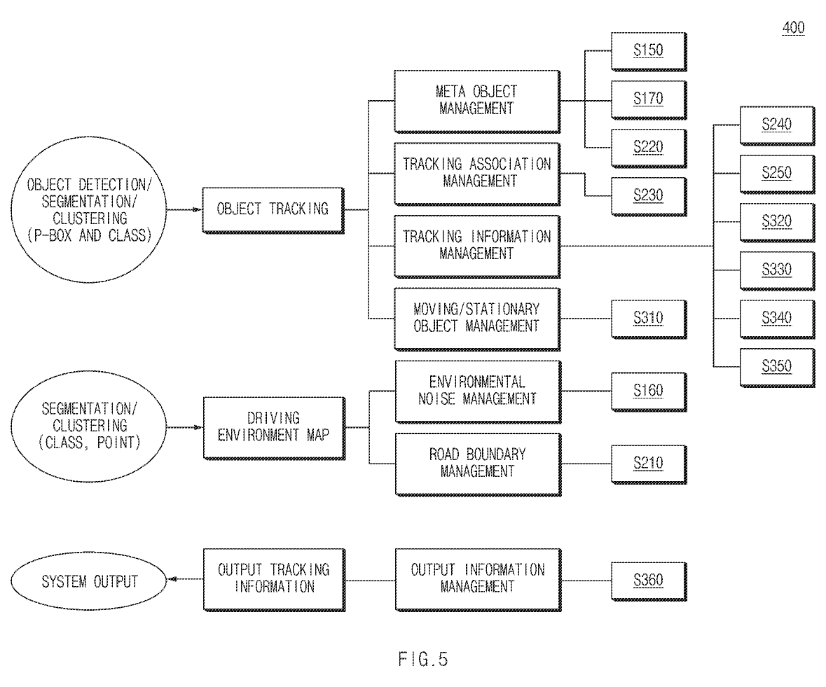

FIG. 5 is a block diagram 400 showing a functional module corresponding to each sub-process of an algorithm for tracking an object based on an autonomous driving sensor and an AI from a multi-object tracking viewpoint, according to an example of the present disclosure (e.g., sub-processes for detection, clustering, classification, association, or memory tracking, etc.).

In FIG. 5, it is easy to understand a multi-object tracking module supported by a sub-process of the present disclosure, by matching key features of the present disclosure described in FIGS. 2-4 from a functional point view of multi-object tracking (e.g., association management, false track removal, reliability scoring, or occlusion handling, etc.).

As illustrated in FIG. 5, according to the object tracking architecture of the present disclosure, it is possible to improve obstacle avoidance performance during autonomous driving and to ensure driving safety by determining collision risk at an early stage. In particular, it is possible to improve recognition performance for an object placed at a long distance (e.g., vehicles at 70–100 m, pedestrians near crosswalks, bicycles in adjacent lanes, or trucks merging from highway ramps, etc.).

In addition, it is possible to secure robustness to special objects or situations and to solve a recognition error for an object in which occlusion occurs. It is possible to improve issues of inaccurate output of an object shape (e.g., a size, a heading, distorted bounding box, heading drift, or elongated shapes, etc.), and to accurately recognize and track an object with robustness to various environmental noises such as exhaust gas, moisture, or crosstalk noise caused by road objects with high light reflectivity (e.g., wet asphalt, traffic mirrors, glass building facades, or metallic poles, etc.). The accuracy of environment recognition may also be improved. For example, under/over-segmentation issues may be improved (e.g., one vehicle split into two objects, multiple pedestrians grouped as one, or road edge merged with a curb, etc.), and the accuracy of ground recognition from ultra-close range data may be improved (e.g., within 1–2 m for curb detection, pothole detection, or lane surface recognition, etc.).

In other words, in the conventional technology, robustness against various limiting situations may not be secured with a signal processing-based logic configuration. Objects with special shapes, bushes encroaching on a road, and exhaust fumes in winter may be a type of environmental noise that interferes with object recognition (e.g., roadside hedges, snow piles, exhaust plumes, or smoke clouds, etc.). Moreover, in the conventional technology, it was difficult to overcome the recognition accuracy of objects, in which there is occlusion where a preceding object obscures another object placed in front of the preceding object (e.g., a car hidden behind a bus, a pedestrian hidden behind a truck, or a bicycle hidden behind a vehicle, etc.). Besides, in the case of a conventional technology, there were limitations in autonomous driving sensor specifications and limitations in detection performance of noise in HW characteristics, and there were always issues such as excessively merged clustering (a vehicles or a pedestrian merged with a road structure, e.g., a vehicle merged with a guardrail, a pedestrian merged with a roadside pole, or a bicycle merged with a lane marker, etc.) due to crosstalk noise and resolution performance limitations.

Accordingly, the present disclosure determines that a management technology for separation and merging between tracking channels is necessary to improve the object separation performance. The present disclosure proposes the above-described technology to overcome inaccuracies of the shape, size, and heading of a large truck, a distant object, bushes entangled in guardrails, a hidden object, a hidden pedestrian, or a partially occluded motorcycle, etc.

Besides, the present disclosure proposes the architecture capable of coping with various limit situations with a logic configuration based on signal processing. For example, misrecognition issues regarding a vehicle merged with bushes may be improved by developing a logic configuration for determining bushes invading a road (e.g., roadside vegetation, hedges, or tree branches, etc.). The determination accuracy of the location and shape thereof may be improved by accurately analyzing road boundaries and a location of a driving lane of a moving object (e.g., lane centerlines, road shoulders, or lane merges, etc.), and determining an object in a moving/stationary state through selecting a vehicle close to a host vehicle (e.g., the nearest leading car, a merging car, or a stopped bus ahead, etc.).

Additionally, in the present disclosure, issues of excessively merged clustering (a vehicles or a pedestrian merged with a road structure, e.g., a vehicle merged with a road barrier, a pedestrian merged with a street sign, or two cars merged as one, etc.) due to the above-described resolution performance limitations may be improved, and issues such as crosstalk noise and excessive merged clustering may be solved by using meta verification logic to improve limitations of autonomous driving sensor specifications and detection performance limitations of noise of HW characteristics (e.g., reflections from wet surfaces, glass, metallic guardrails, or reflective road markers, etc.).

Furthermore, as illustrated in FIG. 5, the present disclosure improves the performance of removing noise such as false targets caused by exhaust gas or road signs by using false track management logic (e.g., exhaust plumes, exhaust heat waves, reflective license plates, or roadside billboards, etc.). In the case of occlusion, while the recognition performance of occluded objects is improved by generating a virtual track by accumulated information by using tracking channel verification logic, a method is proposed to remove distant objects and crosstalk noise through memory tracking (e.g., retaining a track for a vehicle behind a bus, removing spurious tracks from reflective road signs, or eliminating long-range ghost objects, etc.).

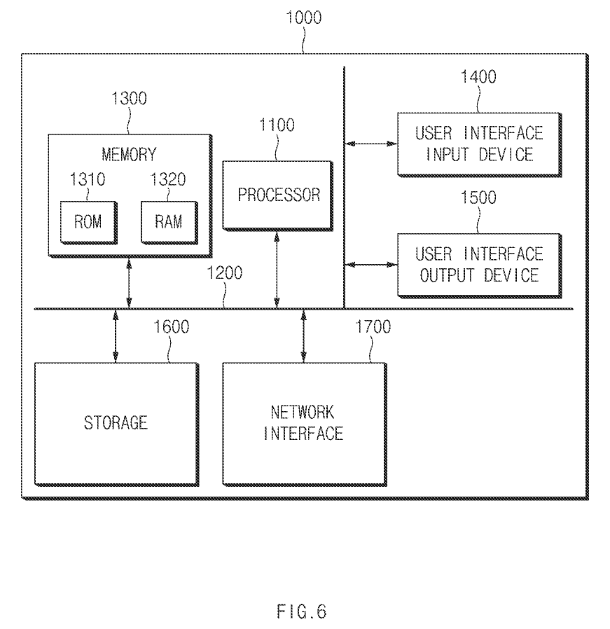

FIG. 6 shows an example of a computing system 1000 for autonomous vehicle control and object recognition operations, according to an example of the present disclosure (e.g., handling perception, planning, and control modules, etc.).

Referring to FIG. 6, a computing system 1000 may include at least one processor 1100, a memory 1300, a user interface input device 1400, a user interface output device 1500, a storage 1600, and a network interface 1700, which are connected with each other via a bus 1200 (e.g., PCIe bus, CAN bus, or Ethernet bus, etc.).

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM) (e.g., DRAM, SRAM, DDR RAM, or LPDDR, etc.).

Accordingly, the operations of the method or algorithm described in connection with the examples disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM) (e.g., USB flash drive, SD card, or solid-state drive (SSD), etc.).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal (e.g., discrete CPU and memory chips, GPU with dedicated VRAM, or FPGA with external storage, etc.).

According to an example of the present disclosure, a system for recognizing an object by using an AI module and an autonomous driving sensor includes a processor equipped with an object recognition module that recognizes an object placed in a surrounding environment from pieces of point data input from the autonomous driving sensor, as a part of the AI module, and a memory that stores the input pieces of point data. The AI module performs a first step of receiving class information of a corresponding object, and P-Box information generated through segmentation and clustering for object detection from the pieces of point data and tracking an object, a second step of generating a driving environment map required for autonomous driving from the P-Box information, the class information, and the pieces of point data, and a third step of outputting tracking information about the object based on the first step and the second step. In the third step, information, in which a time delay is compensated, is output.

According to the second example of the present disclosure, in a system for recognizing and tracking an object, the first step includes updating information about a host vehicle based on information about a transverse speed, a longitudinal speed, or an angle of the host vehicle equipped with the autonomous driving sensor.

According to the second example of the present disclosure, in a system for recognizing and tracking an object, the first step includes selecting a meta object based on the P-Box information and the class information.

According to the fourth example of the present disclosure, in a system for recognizing and tracking an object, information about the meta object includes information about bushes on a road.

According to the fifth example of the present disclosure, in a system for recognizing and tracking an object, a meta object excluded from a priority by determining a priority between the meta objects is excluded from an operation process in the second step and the third step if a number of the meta object exceeds a number of output tracking channels of the autonomous driving sensor.

According to the sixth example of the present disclosure, in a system for recognizing and tracking an object, information about the meta object includes at least one of under-segmentation, over-segmentation, a curb noise object, an object including crosstalk noise, or an object with occlusion.

According to the seventh example of the present disclosure, in a system for recognizing and tracking an object, the AI module further performs a fourth step of generating a new tracking channel for a meta object, which does not include a tracking association among the meta object, and selecting a meta object, which is not associated with an existing tracking channel among the meta object, as a memory tracking target.

According to the eighth example of the present disclosure, in a system for recognizing and tracking an object, tracking channel information about the meta object is updated, and tracking heading information about the meta object is updated based on whether the meta object is driving at a low speed or a high speed, based on a specific threshold value.

According to the ninth example of the present disclosure, in a system for recognizing and tracking an object, the AI module further performs a fifth step of determining there is a false track, based on information about the meta object and clustered point information of the meta object.

According to the tenth example of the present disclosure, in a system for recognizing and tracking an object, the AI module further performs a sixth step of calculating and updating reliability for the tracking channel by using a score, which is obtained by adding reliability for each tracking channel update function to reliability calculated for the meta object, with respect to the meta object.

According to an example of the present disclosure, a method for recognizing an object by pieces of point data from an AI module and an autonomous driving sensor includes a first step of receiving, by the AI module, class information of a corresponding object, and P-Box information generated through segmentation and clustering for object detection from the pieces of point data and tracking an object, a second step of generating a driving environment map required for autonomous driving from the P-Box information, the class information, and the pieces of point data, and a third step of outputting tracking information about the object based on the first step and the second step. In the third step, information, in which a time delay is compensated, is output.

The above description is merely an example of the technical idea of the present disclosure, and various modifications and variations may be made by one skilled in the art without departing from the essential characteristics of the present disclosure.

Accordingly, examples of the present disclosure are intended not to limit but to explain the technical idea of the present disclosure, and the scope and spirit of the present disclosure are not limited by the above examples. The scope of protection of the present disclosure should be construed in accordance with the attached claims, and all equivalents thereof should be construed as being included within the scope of the present disclosure.

According to the object tracking architecture of the present disclosure, it is possible to improve obstacle avoidance performance during autonomous driving and to ensure driving safety by determining a collision risk at an early stage. In particular, it is possible to improve recognition performance for an object placed at a long distance (e.g., objects as far away as 70 m or more).

In addition, it is possible to secure robustness to special objects or situations and to solve a recognition error for an object in which occlusion occurs. It is possible to improve issues of inaccurate output of an object shape (e.g., a size or a heading), and to accurately recognize and track an object with robustness to various environmental noises such as exhaust gas, moisture, or crosstalk noise caused by road objects with high light reflectivity. The accuracy of environment recognition may also be improved. For example, under/over-segmentation issues may be improved, and the accuracy of ground recognition from ultra-close range data may be improved.

The present disclosure solves the following issues.

In other words, robustness to various limiting situations may not be secured with a signal processing-based logic configuration. Objects with special shapes, bushes encroaching on a road, and exhaust fumes in winter may be a type of environmental noise that interferes with object recognition. Moreover, it may be difficult to overcome the recognition accuracy of objects, in which there is occlusion where a preceding object obscures another object placed in front of the preceding object. Besides, there may be limitations in autonomous driving sensor specifications and limitations in detection performance of noise in HW characteristics, and there may be issues such as excessively merged clustering (a vehicle or a pedestrian merged with a road structure) due to crosstalk noise and resolution performance limitations.

Accordingly, the present disclosure determines that a management technology for separation and merging between tracking channels is necessary to improve the object-separation performance. The present disclosure proposes the above-described technology to overcome inaccuracies in the shape, size, and heading of a large truck, a distant object, bushes entangled in guardrails, or a hidden object.

Besides, the present disclosure proposes an architecture capable of coping with various limit situations with a logic configuration based on signal processing. For example, misrecognition issues regarding a vehicle merged with bushes may be improved by developing a logic configuration for determining bushes invading a road. The determination accuracy of the location and shape thereof may be improved by accurately analyzing road boundaries and a location of a driving lane of a moving object, and determining an object in a moving/stationary state by selecting a vehicle close to a host vehicle.

Additionally, in the present disclosure, issues of excessively merged clustering (a vehicle or a pedestrian merged with a road structure) due to the above-described resolution performance limitations may be improved, and issues such as crosstalk noise and excessive merged clustering may be solved by using meta verification logic to improve limitations of autonomous driving sensor specifications and detection performance limitations of noise in HW characteristics.

Furthermore, the present disclosure improves the performance of removing noise such as false targets caused by exhaust gas or road signs by using false track management logic. In the case of occlusion, while the recognition performance of occluded objects is improved by generating a virtual track from accumulated information using tracking channel verification logic, a method is proposed to remove distant objects and crosstalk noise through memory tracking.

Besides, through the detailed description of the present disclosure and the attached drawings, those skilled in the art may understand various effects other than the effects described above from the present disclosure.

Hereinabove, although the present disclosure was described with reference to examples and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. An apparatus of a vehicle, the apparatus comprising:
a sensor configured to obtain pieces of point data associated with an object in a surrounding environment of the vehicle;
a memory configured to store the pieces of point data; and
a processor circuit configured to:
recognize, based on the pieces of point data, the object, wherein the pieces of point data are processed based on an artificial intelligence (AI) model associated with autonomous driving of the vehicle,
obtain class information of the object and predicted bounding box (P-Box) information, wherein the P-Box information is obtained through segmentation and clustering of the pieces of point data, wherein the object is tracked based on the P-Box information,
based on the P-Box information, the class information, and the pieces of point data, generate a driving environment map associated with autonomous driving of the vehicle,
output, based on the class information and the driving environment map, a signal indicating tracking information about the object, wherein the tracking information is adjusted to compensate for a time delay between the obtaining of the pieces of point data and the output of the signal, and
control, based on the signal, autonomous driving of the vehicle.

2. The apparatus of claim 1, wherein the processor circuit is configured to:
update information about the vehicle based on information about at least one of a transverse speed of the vehicle, a longitudinal speed of the vehicle, or an angle of the vehicle, and
generate tracking information based on at least one of:
updating tracking channels associated with the segmentation and the clustering of the pieces of point data,
verifying the tracking channels to remove false tracks caused by noise,
generating a new tracking channel for a cluster of point data not associated with an existing tracking channel, or
retaining a tracking channel for a second cluster of point data when the second cluster is not associated with point data in a current frame obtained by the sensor.

3. The apparatus of claim 1, wherein the processor circuit is configured to:
based on the P-Box information and the class information, select at least one meta object among a plurality of meta objects in the surrounding environment of the vehicle.

4. The apparatus of claim 3, wherein the at least one meta object comprises bushes in the surrounding environment of the vehicle.

5. The apparatus of claim 3, wherein the processor circuit is configured to:
based on a number of the plurality of meta objects exceeding a number of output tracking channels associated with the sensor, determine priorities of the plurality of meta objects, and
exclude, based on the priorities, the at least one meta object from the generation of the driving environment map and the output of the signal.

6. The apparatus of claim 3, wherein the at least one meta object comprises at least one of:
a meta object resulting from under-segmentation in which multiple objects are grouped as one,
a meta object resulting from over-segmentation in which a single object is divided into multiple objects,
a curb noise object,
an object comprising crosstalk noise, or
an object with occlusion.

7. The apparatus of claim 3, wherein the processor circuit is configured to:
based on the at least one meta object not being associated with an existing tracking channel, generate a new tracking channel for the at least one meta object, and
set the at least one meta object as a memory tracking target.

8. The apparatus of claim 3, wherein the processor circuit is configured to:
update tracking channel information associated with the at least one meta object, and
based on whether a speed of the at least one meta object satisfies a threshold value, update tracking heading information associated with the at least one meta object.

9. The apparatus of claim 3, wherein the processor circuit is configured to:
based on clustered point information associated with the at least one meta object, determine whether a track of the at least one meta object is a false track.

10. The apparatus of claim 3, wherein the processor circuit is configured to:
determine a channel reliability level for a tracking channel associated with the at least one meta object, wherein the channel reliability level is determined based on a sum of reliability levels associated with updating the tracking channel and an object reliability level obtained for the at least one meta object.

11. A method performed by an apparatus of a vehicle, the method comprising:
obtaining, from a sensor of the vehicle, pieces of point data associated with an object in a surrounding environment of the vehicle, wherein the pieces of point data are processed based on an artificial intelligence (AI) model associated with autonomous driving of the vehicle;
obtaining class information of the object and predicted bounding box (P-Box) information, wherein the P-Box information is obtained through segmentation and clustering of the pieces of point data, wherein the object is tracked based on the P-Box information;
based on the P-Box information, the class information, and the pieces of point data, generating a driving environment map associated with autonomous driving of the vehicle;
outputting, based on the class information and the driving environment map, a signal indicating tracking information about the object, wherein the tracking information is adjusted to compensate for a time delay between the obtaining of the pieces of point data and the outputting of the signal; and
controlling, based on the signal, autonomous driving of the vehicle.

12. The method of claim 11, wherein the obtaining of the class information and the P-Box information comprises:
updating information about the vehicle based on information about at least one of a transverse speed of the vehicle, a longitudinal speed of the vehicle, or an angle of the vehicle.

13. The method of claim 11, wherein the obtaining of the class information and the P-Box information comprises:
based on the P-Box information and the class information, selecting at least one meta object among a plurality of meta objects in the surrounding environment of the vehicle.

14. The method of claim 13, wherein the at least one meta object comprises bushes in the surrounding environment of the vehicle.

15. The method of claim 13, further comprising:
based on a number of the plurality of meta objects exceeding a number of output tracking channels associated with the sensor, determining priorities of the plurality of meta objects; and
excluding, based on the priorities, the at least one meta object from the generating of the driving environment map and the outputting of the signal.

16. The method of claim 13, wherein the at least one meta object comprises at least one of:
a meta object resulting from under-segmentation in which multiple objects are grouped as one,
a meta object resulting from over-segmentation in which a single object is divided into multiple objects,
a curb noise object,
an object comprising crosstalk noise, or
an object with occlusion.

17. A vehicle comprising:
a sensor configured to obtain point data representing an external environment of the vehicle;
a driving control circuit configured to control autonomous driving of the vehicle; and
a processor circuit configured to cause the vehicle to:
segment the point data into segmented point data, and cluster the segmented point data into clusters,
obtain, based on the clusters, class information of an object represented by the clusters,
generate a driving environment map based on the class information, the clusters, and the point data,
track, based on the driving environment map, the object across time to generate tracking information of the object, wherein the tracking information is generated based on at least one of:
updating tracking channels associated with the clusters,
verifying the tracking channels to remove false tracks caused by noise,
generating a new tracking channel for a cluster of point data not associated with an existing tracking channel, or
retaining a tracking channel for a second cluster of point data when the second cluster is not associated with point data in a current frame obtained by the sensor,
output a signal indicating the tracking information of the object; and
control, via the driving control circuit and based on the signal, autonomous driving of the vehicle.

18. The vehicle of claim 17, wherein the processor circuit is configured to cause the vehicle to update the driving environment map with road boundary information and a closest in-path vehicle.

19. The vehicle of claim 17, wherein the processor circuit is configured to cause the vehicle to remove false tracks corresponding to at least one of exhaust fumes, road signs, or crosstalk noise.

20. The vehicle of claim 17, wherein the processor circuit is configured to cause the vehicle to:
generate a virtual track based on previously detected point data of the object, and
retain, based on the virtual track, a tracking channel for an occluded object.
